(19) United States
(12) Patent Application Publication
(10) Pub. No.: US 2025/0015906 A1
(43) Pub. Date: Jan. 9, 2025

(54) FLEXIBLE CALIBRATION OF TIME-VARYING OPERATING PARAMETERS IN RF COMMUNICATION SYSTEMS AND DEVICES

(71) Applicant: Anokiwave, Inc., San Diego, CA (US)

(72) Inventors: Kartik Sridharan, San Diego, CA (US); Eythan Familier, San Diego, CA (US)

(21) Appl. No.: 18/664,654

(22) Filed: May 15, 2024

Related U.S. Application Data
(60) Provisional application No. 63/466,529, filed on May 15, 2023.

(51) Int. Cl. H04B 17/12; H04B 17/21; H04L 25/03

(52) U.S. Cl. CPC H04B 17/12; H04B 17/221; H04L 25/03853

(57) ABSTRACT

A compensation system and method involves configuring operating parameters for a RF communication circuit using primary calibration parameters and adjusting for time-varying performance of the RF communication circuit using secondary calibration parameters retrieved from a look-up table based on an environmental factor.

### CROSS-REFERENCE TO RELATED APPLICATION(S)

This patent application claims the benefit of U.S. Provisional Patent Application No. 63/466,529 entitled FLEXIBLE CALIBRATION OF TIME-VARYING OPERATING PARAMETERS IN RF COMMUNICATION SYSTEMS AND DEVICES SUCH AS FOR ERROR VECTOR CONTROL IN PHASED ARRAY SYSTEMS AND DEVICES filed May 15, 2023, which is hereby incorporated herein by reference in its entirety.

### FIELD OF THE INVENTION

The invention generally relates to flexible calibration of time-varying operating parameters in RF communication systems and devices such as for error vector control in phased array systems and devices.

### SUMMARY OF VARIOUS EMBODIMENTS

In accordance with one embodiment of the invention, a compensation system configured to perform a compensation process comprises configuring operating parameters for a RF communication circuit using primary calibration parameters; and adjusting for time-varying performance of the RF communication circuit using secondary calibration parameters retrieved from a look-up table based on an environmental factor.

In various alternative embodiment, the time-varying performance may include phase performance and/or amplitude performance. The environmental factor may include temperature, voltage, and/or frequency and may include a combination of two or more environmental factors. The RF communication circuit may include an RF transmitter or an RF receiver. The compensation system may be embodied in a beamforming integrated circuit that may be configured to operate with 5G protocols and/or with millimeter wave signals. The IC may include a plurality of RF communication circuits that may be compensated independently or collectively. A phased array system may include one or more of such beamforming integrated circuits.

In accordance with another embodiment, a compensation method comprises configuring operating parameters for a RF communication circuit using primary calibration parameters; and adjusting for time-varying performance of the RF communication circuit using secondary calibration parameters retrieved from a look-up table based on an environmental factor. The environmental factor may include temperature, voltage, and/or frequency and may include a combination of two or more environmental factors. The RF communication circuit may include an RF transmitter or an RF receiver.

In any of the above embodiments, there may be two or more chains, and the average phase difference between the chains may be equalized by effecting the phase at point 2.

In accordance with another embodiment, an RF phase compensation system comprises at least one RF communication circuit having a phase parameter that can vary over time based on at least one environmental factor; at least one calibration storage for storing phase calibration parameters including at least a primary phase calibration parameter and a plurality of secondary phase calibration parameters including a distinct secondary phase calibration parameter value for each of a plurality of environmental factor values; and a calibration/compensation controller configured to program the operating parameter based on the primary calibration parameter and reprogram the operating parameter using the secondary calibration parameters based on changes of the at least one environmental factor.

In various embodiments, the secondary phase calibration parameters may be stored in at least one lookup table indexed by values associated with the at least one environmental factor. The at least one RF communication circuit may include a plurality of RF communication circuits, each having a phase shifter; and a mixer that modulates a carrier signal to produce a modulated signal that is distributed to the plurality of RF communication circuits, wherein the phase shifter of each RF communication circuit is programmed with a primary calibration parameter for calibration of the RF communication circuit; the mixer is programmed with a primary calibration parameter for calibration of the mixer based on phase outputs of the RF communication circuits; and at least one of (a) a phase shifter or (b) the mixer is reprogrammed using the secondary calibration parameters based on changes of the at least one environmental factor. The mixer may be calibrated based on an average phase difference of the RF communication circuits relative to an external reference.

Additional embodiments may be disclosed and claimed.

### BACKGROUND OF THE INVENTION

Error vector control is important in the operation of phased array systems and other RF communication systems. Error vector control generally involves carefully calibrating operating parameters such as phase and gain parameters used in RF communication systems such as in beamforming integrated circuits and other RF communication systems and devices. One problem with such operating parameters is that they can vary over time, e.g., due to changes in environmental factors such as temperature, voltage, etc. Thus, in order to compensate for such time-varying operating parameters, the RF communication device/system generally needs to be re-calibrated from time to time, which in some cases involves having to take the RF communication device/system offline from time to time. Such offline modes may be disruptive or unpermitted in some communication systems.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an active electronically steered antenna system (“AESA system”) configured in accordance with certain illustrative embodiments of the invention and communicating with an orbiting satellite.

FIG. 2 schematically shows an AESA system configured in accordance with certain illustrative embodiments of the invention and implemented as a radar system in which a beam-formed signal may be directed toward an aircraft or other object in the sky (e.g., to detect or track position of the object).

FIG. 3 schematically shows an AESA system 10 configured in accordance with certain illustrative embodiments of the invention and implemented as a wireless communication system (e.g., 5G) in which a beam-formed signal may be directed toward a particular user (e.g., to increase the effective transmit range of the AESA system or to allow for greater frequency reuse across adjacent or nearby cells).

FIG. 4 schematically shows a plan view of a primary portion of an AESA system in which each beam forming integrated circuit (BFIC) is connected to four beam forming elements, in accordance with illustrative embodiments of the invention.

FIG. 5 schematically shows a close-up of a portion of the phased array of FIG. 4.

FIG. 6 is a high-level schematic diagram of a four-channel dual-mode BFIC chip in accordance with one exemplary embodiment.

FIG. 7 is a detailed schematic diagram of the BFIC chip of FIG. 6, in accordance with one exemplary embodiment.

FIG. 8 is a schematic diagram showing an RF communication device/system in accordance with one exemplary embodiment.

FIG. 9 is a schematic diagram of an RF transmitter circuit in which phase is controlled using primary and secondary calibration parameters as discussed with reference to FIG. 8 in accordance with one exemplary embodiment.

FIG. 10 is a schematic diagram of an RF transmitter circuit including an integral environmental detector, in accordance with one exemplary embodiment.

FIG. 11 is a schematic diagram of an RF communication device/system having multiple transmitters and/or receivers in which calibration involves measuring characteristics of all of the transmitters (or receivers) relative to one of them and then making corrections at point 1, e.g., so that all of the transmitters (or receivers) are synchronized with regard to a particular operating parameter (e.g., phase, amplitude, etc.) and then the average phase can be measured relative to an external reference and used to make corrections at point 2.

FIG. 12 is a schematic diagram showing details of a specific synthesizer circuit that can be used for both synchronizing the synthesizer with other synthesizers and to compensate for time-varying phase performance using mechanisms described herein.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

Definitions. As used in this description and the accompanying claims, the following terms shall have the meanings indicated, unless the context otherwise requires:

A “set” includes one or more members.

A “beam forming element” (sometimes referred to simply as an “element” or “radiating element”) is an element that is used to transmit and/or receive a signal for beam forming. Different types of beam forming elements can be used for different beam forming applications. For example, the beam forming elements may be RF antennas for RF applications (e.g., radar, wireless communication system such as 5G applications, satellite communications, etc.), ultrasonic transducers for ultrasound applications, optical transducers for optical applications, microphones and/or speakers for audio applications, etc. Typically, the signal provided to or from each beam forming element is independently adjustable, e.g., as to gain/amplitude and phase.

A “beam-formed signal” is a signal produced by or from a plurality of beam forming elements. In the context of the present invention, there is no requirement that a beam-formed signal have any particular characteristics such as directionality or coherency.

A “phased array system” is a system that includes a plurality of beam forming elements and related control logic for producing and adapting beam-formed signals.

The terms “environmental factor” and “environmental factor value” can relate to a single environmental factor (e.g., temperature, voltage, frequency, etc.) or a combination of environmental factors (e.g., temperature and voltage, temperature and frequency, voltage and frequency, temperature and voltage and frequency, etc.).

For convenience, the term “beam forming” is sometimes abbreviated herein as “BF.”

Various embodiments are described herein in the context of active electronically steered antenna (AESA) systems also called Active Antenna, although the present invention is in no way limited to AESA systems. AESA systems form electronically steerable beams that can be used for a wide variety of applications. Although certain details of various embodiments of an AESA system are discussed below, those skilled in the art can apply some embodiments to other AESA systems. Accordingly, discussion of an AESA system does not necessarily limit certain other embodiments.

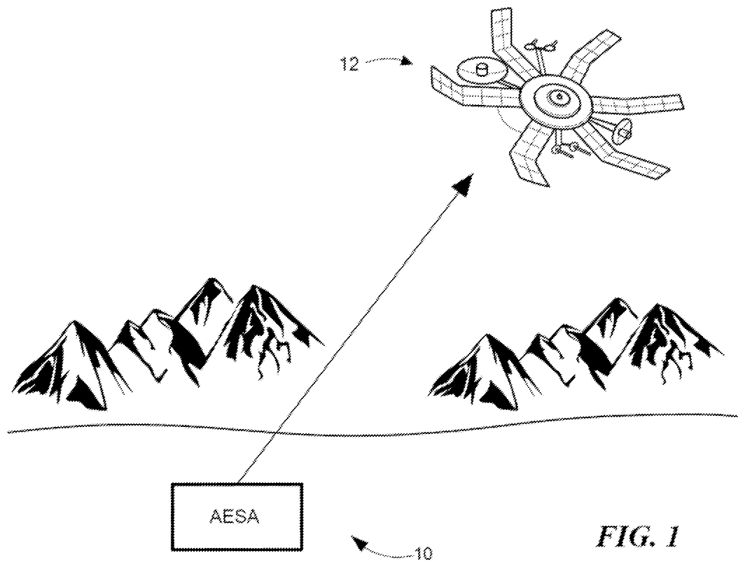

FIG. 1 schematically shows an active electronically steered antenna system (“AESA system 10”) configured in accordance with certain illustrative embodiments of the invention and communicating with an orbiting satellite 12. A phased array (discussed in more detail below and referenced as phased array 10A) implements the primary functionality of the AESA system 10. Specifically, as known by those skilled in the art, the phased array forms one or more of a plurality of electronically steerable beams that can be used for a wide variety of applications. As a satellite communication system, for example, the AESA system 10, preferably is configured operate at one or more satellite frequencies. Among others, those frequencies may include the Ka-band, Ku-band, and/or X-band. Of course, as satellite communication technology progresses, future implementations may modify the frequency bands to communicate using new satellite frequencies.

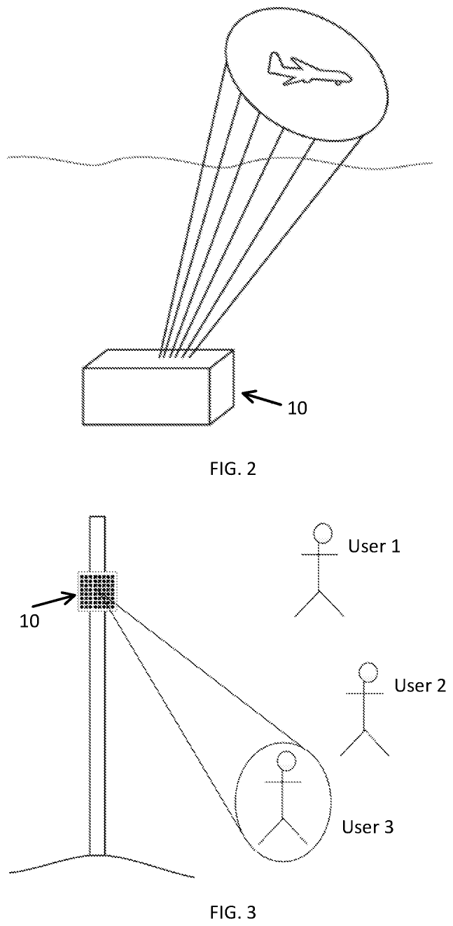

FIG. 2 schematically shows an AESA system 10 configured in accordance with certain illustrative embodiments of the invention and implemented as a radar system in which a beam-formed signal may be directed toward an aircraft or other object in the sky (e.g., to detect or track position of the object).

FIG. 3 schematically shows an AESA system 10 configured in accordance with certain illustrative embodiments of the invention and implemented as a wireless communication system (e.g., 5G) in which a beam-formed signal may be directed toward a particular user (e.g., to increase the effective transmit range of the AESA system or to allow for greater frequency reuse across adjacent or nearby cells). Of course, other implementations may include other types of wireless communication systems.

Of course, those skilled in the art use AESA systems 10 and other phased array systems in a wide variety of other applications, such as RF communication, optics, sonar, ultrasound, etc. Accordingly, discussion of satellite, radar, and wireless communication systems are not intended to limit all embodiments of the invention.

The satellite communication system may be part of a cellular network operating under a known cellular protocol, such as the 3G, 4G (e.g., LTE), or 5G protocols. Accordingly, in addition to communicating with satellites, the system may communicate with earth-bound devices, such as smartphones or other mobile devices, using any of the 3G, 4G, or 5G protocols. As another example, the satellite communication system may transmit/receive information between aircraft and air traffic control systems. Of course, those skilled in the art may use the AESA system 10 in a wide variety of other applications, such as broadcasting, optics, radar, etc. Some embodiments may be configured for non-satellite communications and instead communicate with other devices, such as smartphones (e.g., using 4G or 5G protocols). Accordingly, discussion of communication with orbiting satellites 12 is not intended to limit all embodiments of the invention.

In certain exemplary embodiments, the beam forming elements may be implemented as patch antennas that are formed on one side of a laminar printed circuit board, although it should be noted that the present invention is not limited to patch antennas or to a laminar printed circuit board. In exemplary embodiments, a phased array includes X beam forming integrated circuits (BFICs), with each BFIC supporting Y beam forming elements (e.g., 2 or 4 beam forming elements per BFIC, although not limited to 2 or 4). Thus, such a phased array includes (X*Y) beam forming elements.

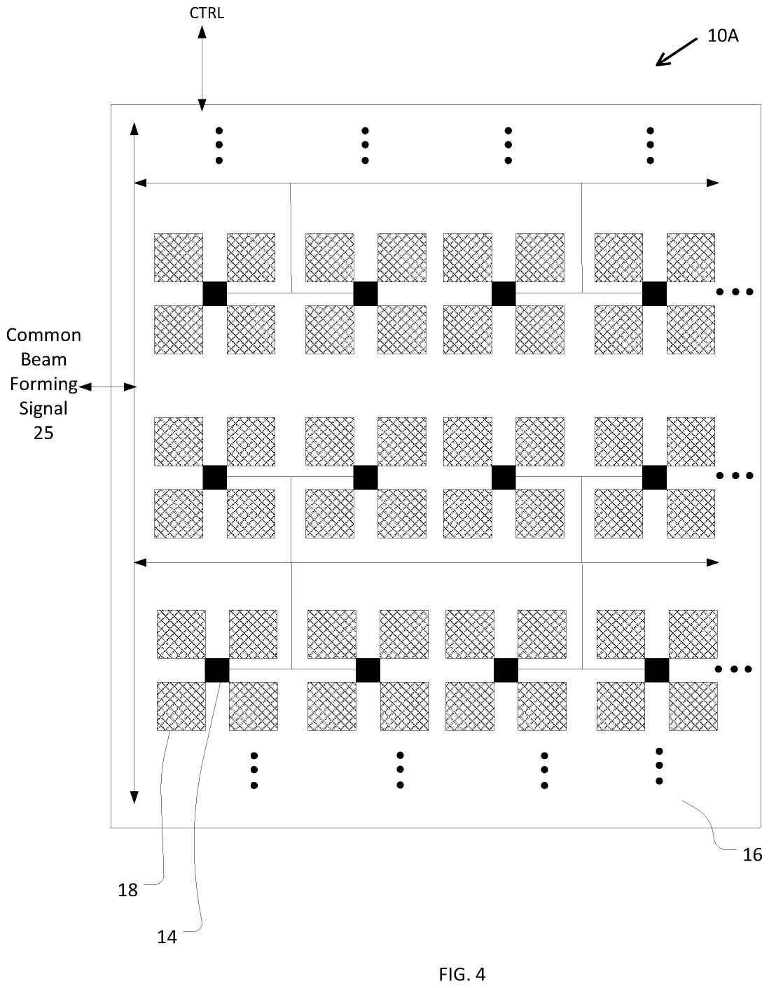

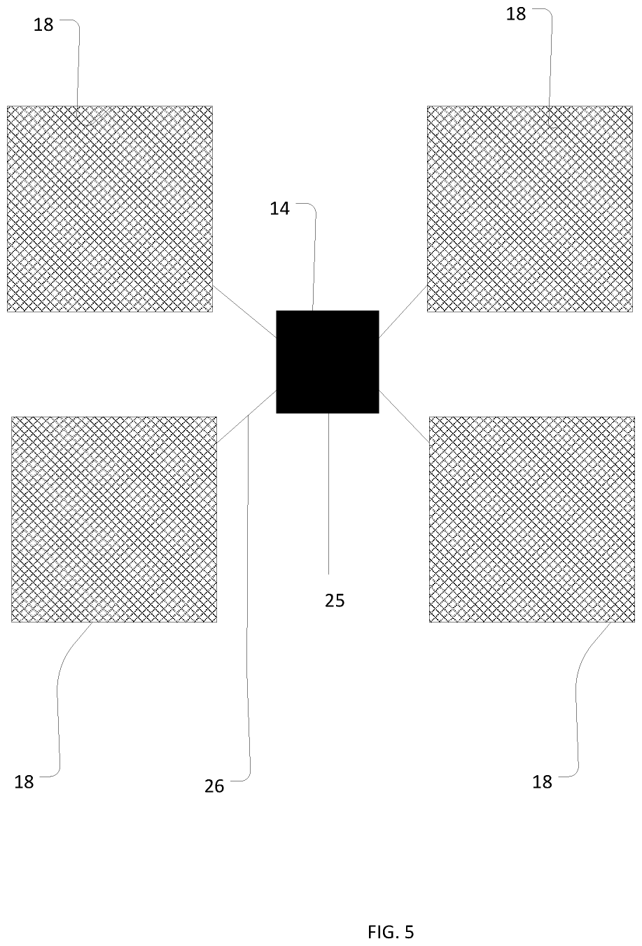

FIG. 4 schematically shows a plan view of a primary portion of an AESA system 10 in which each beam forming integrated circuit 14 is connected to four beam forming elements 18, in accordance with illustrative embodiments of the invention. Each BFIC 14 aggregates signals to/from the connected beam forming elements as part of a common beam forming signal 25. FIG. 5 schematically shows a close-up of a portion of the phased array 10A of FIG. 4.

Specifically, the AESA system 10 of FIG. 4 is implemented as a laminar phased array 10A having a laminated printed circuit board 16 (i.e., acting as the substrate and also identified by reference number “16”) supporting the above noted plurality of beam forming elements 18 and beam forming integrated circuits 14. The elements 18 preferably are formed as a plurality of square or rectangular patch antennas oriented in a patch array configuration. It should be noted that other embodiments may use other patch configurations, such as a triangular configuration in which each integrated circuit is connected to three elements 18, a pentagonal configuration in which each integrated circuit is connected to five elements 18, or a hexagonal configuration in which each integrated circuit is connected to six elements 18. Like other similar phased arrays, the printed circuit board 16 also may have a ground plane (not shown) that electrically and magnetically cooperates with the elements 18 to facilitate operation. In exemplary embodiments, the BFICs are mounted to a back side of the printed circuit board opposite the side containing the patch antennas (e.g., with through-PCB vias and traces that connect to the elements 18, with such connections typically made using impedance controlled lines and transitions), although in alternative embodiments, the BFICs may be mounted to the same side of the printed circuit board as the patch antennas.

As a patch array, the elements 18 have a low profile. Specifically, as known by those skilled in the art, a patch antenna (i.e., the element 18) typically is mounted on a flat surface and includes a flat rectangular sheet of metal (known as the patch and noted above) mounted over a larger sheet of metal known as a “ground plane.” A dielectric layer between the two metal regions electrically isolates the two sheets to prevent direct conduction. When energized, the patch and ground plane together produce a radiating electric field. Illustrative embodiments may form the patch antennas using conventional semiconductor fabrication processes, such as by depositing one or more successive metal layers on the printed circuit board 16. Accordingly, using such fabrication processes, each radiating element 18 in the phased array 10A should have a very low profile. It should be noted that embodiments of the present invention are not limited to rectangular-shaped elements 18 but instead any appropriate shape such as circular patches, ring resonator patches, or other shape patches may be used in other particular embodiments.

The phased array 10A can have one or more of any of a variety of different functional types of elements 18. For example, the phased array 10A can have transmit-only elements 18, receive-only elements 18, and/or dual mode receive and transmit elements 18 (referred to as “dual-mode elements 18”). The transmit-only elements 18 are configured to transmit outgoing signals (e.g., burst signals) only, while the receive-only elements 18 are configured to receive incoming signals only. In contrast, the dual-mode elements 18 are configured to either transmit outgoing burst signals, or receive incoming signals, depending on the mode of the phased array 10A at the time of the operation. Specifically, when using dual-mode elements 18, the phased array 10A generally can be in either a transmit mode, or a receive mode.

The AESA system 10 has a plurality of the above noted integrated circuits 14 (mentioned above with regard to FIG. 5) for controlling operation of the elements 18. Those skilled in the art sometimes refer to these integrated circuits 14 as “beam steering integrated circuits.” Each integrated circuit 14 preferably is configured with at least the minimum number of functions to accomplish the desired effect. Indeed, integrated circuits 14 for dual mode (transmit and receive) elements 18 are expected to have some different functionality than that of the integrated circuits 14 for transmit-only elements 18 or receive-only elements 18. Accordingly, integrated circuits 14 for such non-dual-mode elements 18 typically have a smaller footprint than the integrated circuits 14 that control the dual-mode elements 18. Despite that, some or all types of integrated circuits 14 fabricated for the phased array 10A can be modified to have a smaller footprint.

As an example, depending on its role in the phased array 10A, each integrated circuit 14 may include some or all of the following functions:
phase shifting,
amplitude controlling/beam weighting,
switching between transmit mode and receive mode,
output amplification to amplify output signals to the elements 18,
input amplification for received RF signals (e.g., signals received from the satellite 12), and
power combining/summing and splitting between elements 18.

Indeed, some embodiments of the integrated circuits 14 may have additional or different functionality, although illustrative embodiments are expected to operate satisfactorily with the above noted functions. Those skilled in the art can configure the integrated circuits 14 in any of a wide variety of manners to perform those functions. For example, the input amplification may be performed by a low noise amplifier, the phase shifting may use conventional active phase shifters, and the switching functionality may be implemented using conventional transistor-based switches. Additional details of the structure and functionality of integrated circuits 14 are discussed below.

In illustrative embodiments, multiple elements 18 share the integrated circuits 14, thus reducing the required total number of integrated circuits 14. This reduced number of integrated circuits 14 correspondingly reduces the cost of the AESA system 10. In addition, more surface area on the top face of the printed circuit board 16 may be dedicated to the elements 18.

To that end, each integrated circuit 14 preferably operates on at least one element 18 in the array and typically operates on a plurality of elements 18. For example, as discussed above, one integrated circuit 14 can operate on two, three, four, five, six, or more different elements 18. Of course, those skilled in the art can adjust the number of elements 18 sharing an integrated circuit 14 based upon the application. For example, a single integrated circuit 14 can control two elements 18, three elements 18, four elements 18, five elements 18, six elements 18, seven elements 18, eight elements 18, etc., or some range of elements 18. Sharing the integrated circuits 14 between multiple elements 18 in this manner reduces the required total number of integrated circuits 14, correspondingly reducing the required size of the printed circuit board 16 and cost of the system.

Dual-mode elements 18 may operate in a transmit mode, or a receive mode. To that end, the integrated circuits 14 may generate time division diplex or duplex waveforms so that a single aperture or phased array 10A can be used for both transmitting and receiving. In a similar manner, some embodiments may eliminate a commonly included transmit/receive switch in the side arms (discussed below) of the integrated circuit 14. Instead, such embodiments may duplex at the element 18. This process can be performed by isolating one of the elements 18 between transmit and receive by an orthogonal feed connection. Such a feed connection may eliminate about a 0.8 dB switch loss and improve G/T (i.e., the ratio of the gain or directivity to the noise temperature) by about 1.3 dB for some implementations.

RF interconnect and/or beam forming lines 26 electrically connect the integrated circuits 14 to their respective elements 18. To further minimize the feed loss, illustrative embodiments mount the integrated circuits 14 as close to their respective elements 18 as possible. Specifically, this close proximity preferably reduces RF interconnect line lengths, reducing the feed loss. To that end, each integrated circuit 14 preferably is packaged either in a flip-chipped configuration using wafer level chip scale packaging (WLCSP) or other configuration such as extended wafer level ball-grid-array (eWLB) that supports flip chip, or a traditional package, such as quad flat no-leads package (QFN package).

It should be reiterated that although FIG. 4 shows an exemplary AESA system 10 with some specificity (e.g., specific layouts of the elements 18 and integrated circuits 14), those skilled in the art may apply illustrative embodiments to other implementations. For example, as noted above, each integrated circuit 14 can connect to more or fewer elements 18, or the lattice configuration can be different. Accordingly, discussion of the specific configurations of the AESA system 10 shown in FIG. 4 is for convenience only and not intended to limit all embodiments.

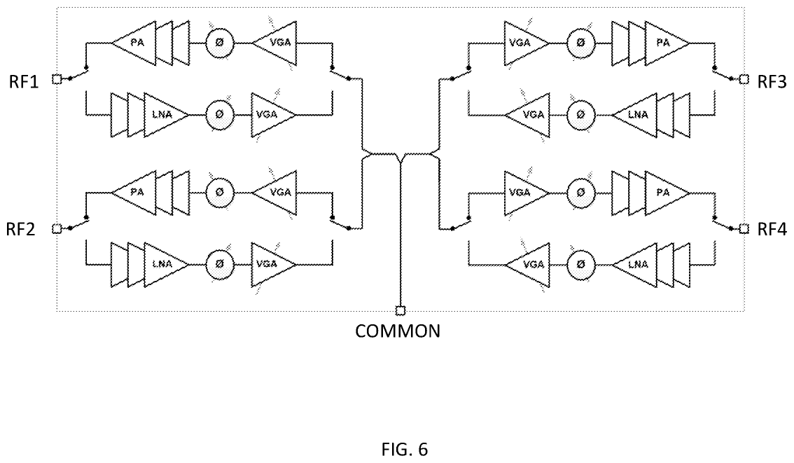

FIG. 6 is a high-level schematic diagram of a four-channel dual-mode BFIC chip in accordance with one exemplary embodiment. Here, each channel has a transmit gain/phase control circuit and a receive gain/phase control circuit that can be switched into and out of the common beam forming signal 25. The transmit gain/phase control circuit includes a variable gain amplifier (VGA), an adjustable phase circuit (Ø), and a power amplifier (PA) stage. The receive gain/phase control circuit includes a low noise amplifier (LNA) stage, an adjustable phase circuit (Ø), and a variable gain amplifier (VGA). In FIG. 6, the BFIC chip is shown with the switches configured in a transmit mode, such that common beam forming signal 25 provided to the BFIC chip is distributed to the four channels. The BFIC chip can be configured in a receive mode by changing the position of the switches, such that signals received on the four channels are output by the BFIC chip as common beam forming signal 25.

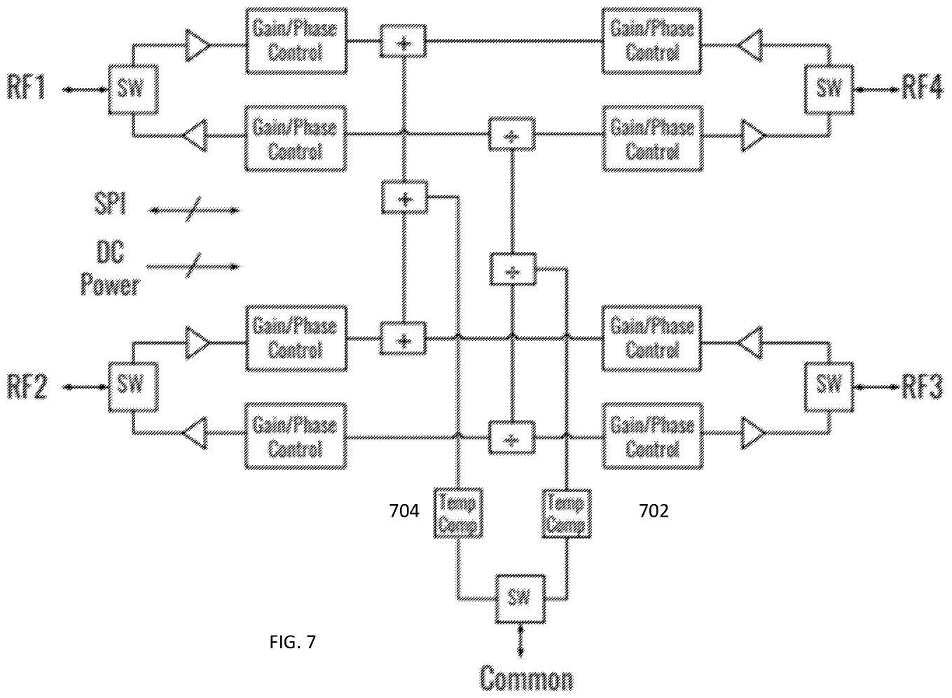

FIG. 7 is a detailed schematic diagram of the BFIC chip of FIG. 6, in accordance with one exemplary embodiment. In this exemplary embodiment, the BFIC chip includes temperature compensation (Temp Comp) circuitry to adjust the gain of the transmit and receive signals as a function of temperature based on inputs from a temperature sensor, although alternative embodiments may omit temperature compensation circuitry. In one exemplary embodiment, each Temp Comp circuit includes a digital attenuator that is controlled based on the sensed temperature. Specifically, in this exemplary embodiment, when temperature decreases such that the gain would increase, attenuation is increased in order provide the desired amount of gain, and when temperature increases such that gain would decrease, attenuation is decreased in order to provide the desired amount of gain. In the exemplary embodiment represented in FIG. 7, temperature compensation is performed on the transmit signal prior to distribution to the four RF channels by Temp Comp circuit 702 and is performed on the combined receive signal by Temp Comp circuit 704. In various alternative embodiments, temperature compensation may be performed in other ways, such as, for example, by controlling of the gain of the transmit and receive RF amplifiers.

Embodiments compensate for time-varying operating parameters such as phase or gain parameters without requiring complex control systems and re-calibration and without taking the RF communication device/system offline by storing primary calibration parameters that essentially represent a default or nominal set of calibration parameters (e.g., calibrated based on known environmental factors such as temperature, voltage, frequency etc.) and secondary calibration parameters for making calibration adjustments based on changes in one or more environmental factors. The primary calibration parameters may be determined, for example, during initial device/system calibration such as during manufacturing or initial device certification. The secondary calibration parameters may be determined at the same time as the initial calibration parameters and in any case may be stored such as in a look-up table (LUT), e.g., indexed by environmental factor such as temperature, voltage, frequency, etc. From time to time, the RF communication device/system may recalibrate the operating parameters using a set of secondary calibration parameters selected based on the then-existing state of environmental factor(s).

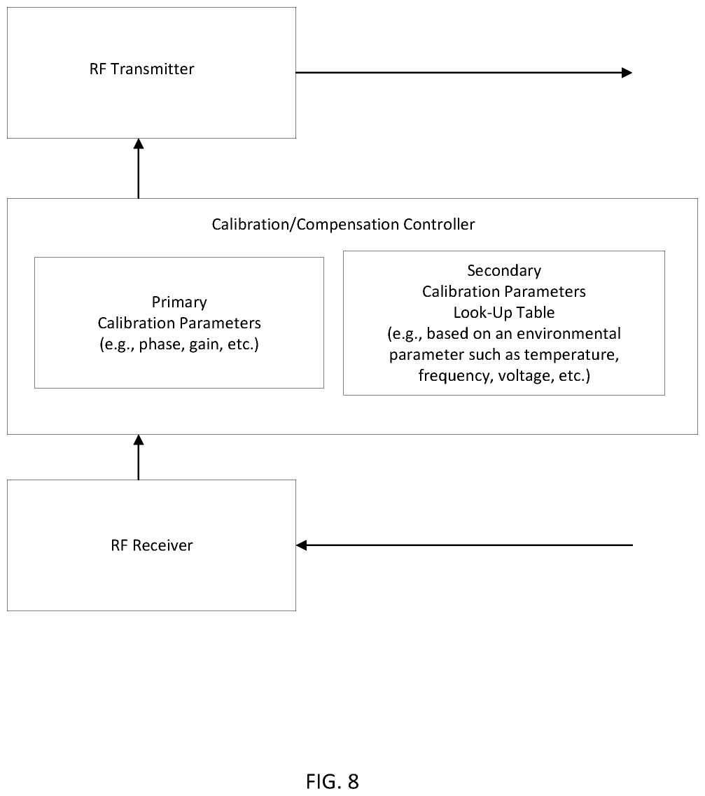

FIG. 8 is a schematic diagram showing an RF communication device/system in accordance with one exemplary embodiment. Among other things, the RF communication device/system includes an RF transmitter, an RF receiver, and a calibration/compensation controller that can compensate for time-varying operating parameters using a LUT to set calibration parameters or make calibration adjustments. Such a calibration/compensation controller can be used in RF communication devices/systems that utilize 5G protocols, although it should be noted that embodiments are not in any way limited to 5G protocols and can be used more generally to perform time-varying operating parameter compensation in a wide range of devices/systems.

For example, without limitation, the calibration/compensation controller could have primary calibration parameters for RF transmitter phase and gain settings and for RF receiver phase and gain settings such as for initial programming of the variable gain and phase circuits. Then, from time to time, the calibration/compensation controller could reprogram the various parameters as a function of one or more variable environmental factors (e.g., temperature, voltage, frequency, etc.).

In certain embodiments, the calibration/compensation controller uses one or more look-up tables to obtain a secondary calibration parameter (which, for example, could be an absolute value or an adjustment value) based on one or more variable environmental factors. For one example, the follow schematically shows a look-up table indexed by an environmental factor value (e.g., a temperature value, a voltage value, a frequency value, etc.) to obtain a secondary calibration parameter:

| Index (Environmental Factor Value) | Secondary Calibration Parameter |
|---|---|
| EFV 1 | Value 1 |
| . | . |
| . | . |
| . | . |
| EFV N | Value N |

Using such a look-up table, the calibration/compensation controller could index the table from time to time based on a current environmental factor value (e.g., from a temperature sensor, voltage sensor, frequency sensor, etc.) to obtain a secondary calibration parameter and then set or adjust an operating parameter (e.g., phase, gain, voltage, etc.) using the obtained value.

For example, without limitation, the calibration/compensation controller could have a look-up table indexed by temperature to obtain a phase setting or adjustment value based on temperature and also could include a look-up table indexed by temperature to obtain a gain setting or adjustment value based on temperature, as depicted schematically as follows:

| Index (Temperature) | Phase |
|---|---|
| Temperature 1 | Value 1 |
| . | . |
| . | . |
| . | . |
| Temperature N | Value N |

| Index (Temperature) | Gain |
|---|---|
| Temperature 1 | Value 1 |
| . | . |
| . | . |
| . | . |
| Temperature N | Value N |

The calibration/compensation controller could have separate tables for the RF transmitter and the RF receiver, as depicted schematically as follows:

| Index (Temperature) | Tx Phase |
|---|---|
| Temperature 1 | Value 1 |
| . | . |
| . | . |
| . | . |
| Temperature N | Value N |

| Index (Temperature) | Tx Gain |
|---|---|
| Temperature 1 | Value 1 |
| . | . |
| . | . |
| . | . |
| Temperature N | Value N |

| Index (Temperature) | Rx Phase |
|---|---|
| Temperature 1 | Value 1 |
| . | . |
| . | . |
| . | . |
| Temperature N | Value N |

| Index (Temperature) | Rx Gain |
|---|---|
| Temperature 1 | Value 1 |
| . | . |
| . | . |
| . | . |
| Temperature N | Value N |

Using such look-up table(s), the calibration/compensation controller could index the tables from time to time based on the current temperature (e.g., from a temperature sensor) to obtain secondary Tx and Rx phase and amplitude calibration parameters and then set or adjust Tx and Rx phase and amplitude settings using the obtained values.

Additionally or alternatively, the calibration/compensation controller could have table(s) indexed by other environmental factors such as indexed by voltage (e.g., a power supply voltage from a voltage sensor), frequency (e.g., a desired transmit or receive frequency), etc.

Where tables exist for multiple environmental factors, the calibration/compensation controller could be configured to combine secondary parameter values from multiple tables according to a predetermined formula (e.g., adding two or more values, averaging two or more values, etc.).

In certain embodiments, secondary calibration parameters can be obtained based on a combination of two or more environmental factors such as based on a combination of temperature and voltage, e.g., using multidimensional or nested tables. The following schematically shows one type of multidimensional or nested look-up table system indexed by temperature and voltage to obtain values for setting or adjusting phase or amplitude settings:

TEMPERATURE TABLE

| Index (temperature) | Link to Voltage Table |
|---|---|
| Temp 1 | Voltage Table 1 |
| . | . |
| . | . |
| . | . |
| Temp N | Voltage Table N |

VOLTAGE TABLE 1

| Index (voltage) | Secondary Calibration Parameter |
|---|---|
| Voltage 1 | Value 1 |
| . | . |
| . | . |
| . | . |
| Voltage M | Value M |

VOLTAGE TABLE N

| Index (voltage) | Secondary Calibration Parameter |
|---|---|
| Voltage 1 | Value 1 |
| . | . |
| . | . |
| . | . |
| Voltage M | Value M |

Thus, for example, the calibration/compensation controller could index the temperature table based on a current temperature value to obtain a link (e.g., a reference) to a voltage table and then index the voltage table based on a current voltage value to obtain a secondary parameter value.

It should be noted that embodiments can be extended to any number of environmental parameter values, e.g., a temperature table that includes links to voltage tables, where each voltage table includes links to frequency tables, etc.

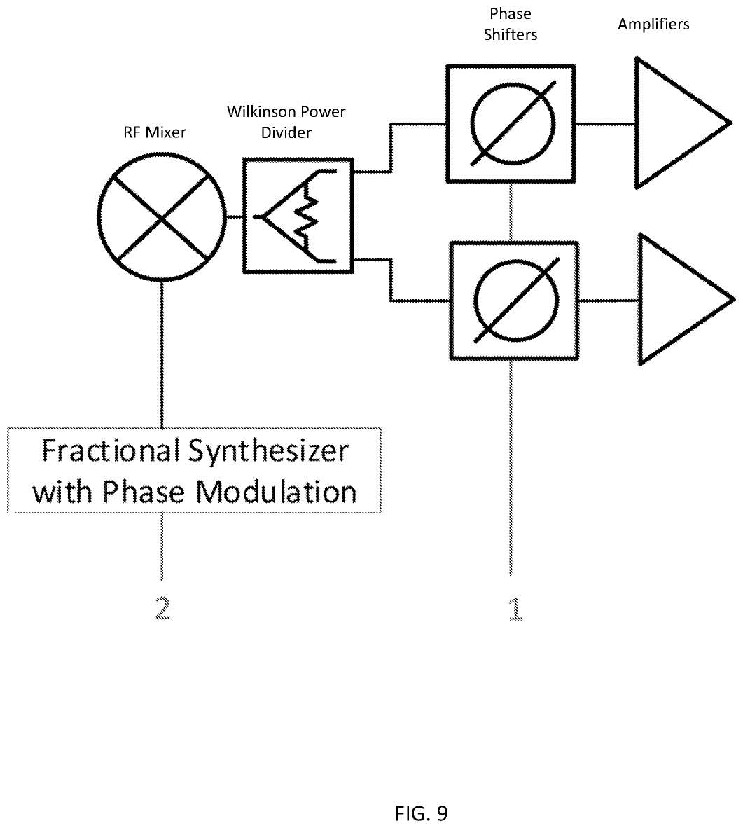

In certain exemplary embodiments, errors relating to phase and/or amplitude are controlled using existing phase shifters and synthesizer inputs using the above-described scheme without requiring complex control systems and re-calibration. FIG. 9 is a schematic diagram of an RF transmitter circuit in which phase is controlled using primary and secondary calibration parameters as discussed with reference to FIG. 8 in accordance with one exemplary embodiment, although it should be noted that similar concepts can be applied equally to a receiver. Among other things, the RF transmitter circuit includes a mixer that modulates a carrier signal to produce a modulated signal and distribution network (e.g., a Wilkinson power divider in this example) that distributes the modulated signal to multiple beamforming signal paths, each beamforming signal path includes in this example a phase shifter for adjusting the phase of the signal such as for beamforming and a variable-gain amplifier for amplifying the signal for transmission such as over a corresponding phased array antenna element. It should be noted that embodiments can include any number of beamforming signal paths, e.g., a beamforming integrated circuit might include two, four, or eight beamforming signal paths.

Phase and/or amplitude performance initially can be measured using either (1) external test equipment or (2) an internal feedback receiver to determine primary operating parameters that are programmed into the transmitter at point 1 shown in FIG. 9 along with beamforming phase/amplitude settings (e.g., phase differences may be programmed as phase offsets into the phase shifters). For example, if the top beamforming signal path shown in FIG. 9 measured at a phase offset of 0° and the bottom beamforming signal path shown in FIG. 9 measured at a phase offset of 50°, then the bottom beamforming signal path might be programmed with a primary phase offset of −50° in order to equalize it with the top beamforming signal path (e.g., a phase offset of −50° might be applied to any beamforming phase setting provided to the bottom beamforming signal path).

Then, in order to compensate for time-varying phase operation, any variations in the mixer/LO path due to changes in environmental factor such as temperature, voltage, frequency, etc. can be either calibrated or compensated using look-up tables and programmed into the synthesizer at point 2 shown in FIG. 9.

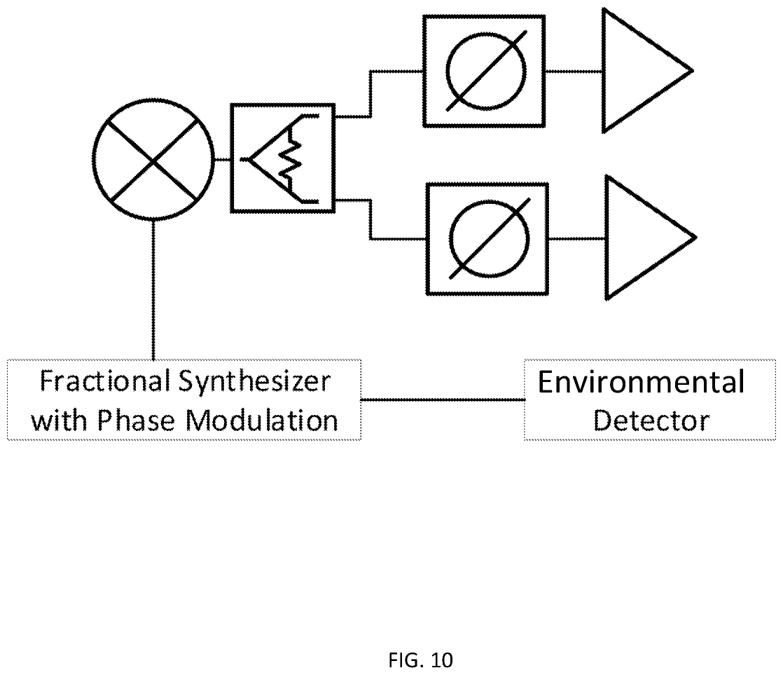

As shown schematically in FIG. 10, the RF communication device/system may include one or more environmental detectors such as a temperature detector, a voltage detector, a frequency detector, etc. to provide input to the calibration/compensation controller for selecting a set of secondary calibration parameters from the LUT. For example, RF integrated circuits such as beamforming integrated circuits may include a calibration/compensation controller and also may include one or more environmental detectors such as a temperature detector, which, among other things, would allow each such RF integrated circuit in a phased array system to independently compensate for variations in temperature and/or other environmental factor, as it is known that different RF ICs in a phased array system may be subjected to different temperatures and temperature variations over time.

Alternatively, data regarding environmental factors may be provided to the RF communication device/system by an external controller. Any variation that is not known a priori, e.g., not having been characterized in advance, may be measured using more traditional calibration techniques (e.g., using a feedback receiver, which might involve taking the RF communication device/system offline for calibration) with the results stored in the LUT for later use. Thus, for example, the RF communication device/system could use more traditional calibration techniques to “learn” calibration parameters on-the-fly but store values for later use so that such traditional calibration techniques do not need to be repeated, e.g., for a given temperature or temperature change.

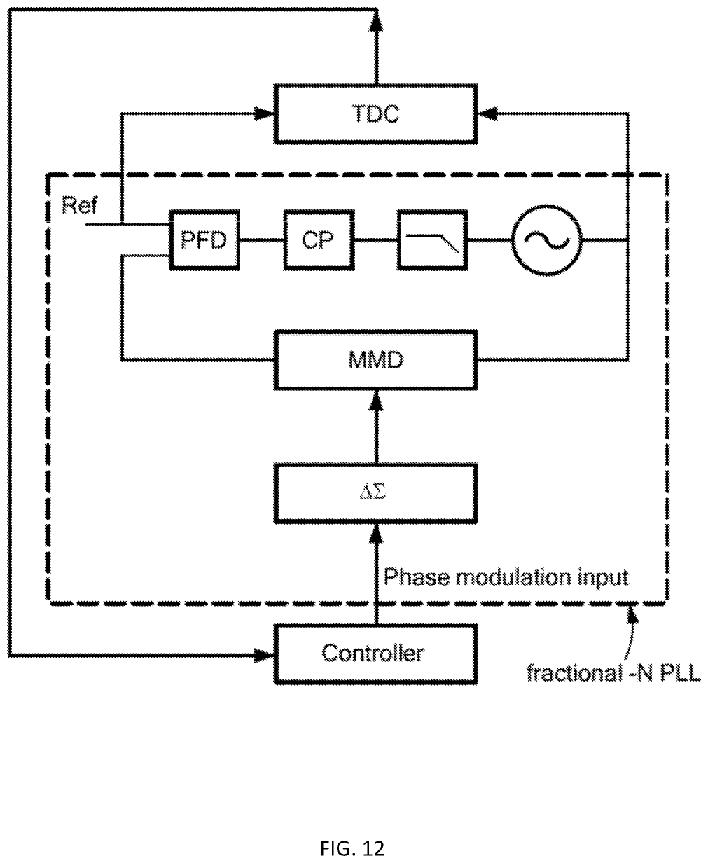

In certain exemplary embodiments, point 2 shown in FIG. 9 may be a phase modulation input used for synchronizing multiple synthesizers, e.g., as disclosed in commonly-owned U.S. Published Patent Application No. 2021/0021402 published Jan. 21, 2021, which is hereby incorporated herein by reference in its entirety. FIG. 12 is a copy of FIG. 4 from this published patent application. Here, the synthesizer circuit includes a synthesizer in the form of a fractional-N delta sigma phase-locked loop (PLL) and a phase measurement circuit in the form of a time-to-digital (TDC) converter. The synchronization circuit here includes the existing delta sigma modulator and multiple modulus divider of the PLL, which are used to adjust the phase operation of the PLL based on the phase modulation input from the controller. The TDC has two inputs, one input coupled to a common reference signal and the other input coupled to the PLL output signal. At various times, the TDC measures the time difference between the reference signal and the PLL output signal and provides one or more time measurements, which can be stored in a digital register and/or provided to an internal or external controller, e.g., via a bus interface. The controller uses the time measurement(s) to determine a synthesizer adjustment value, which, in this example is a phase modulation adjustment (e.g., a negative time adjustment) that is fed into the existing delta sigma in the PLL as a phase modulator input for adjusting the operation of the PLL to align the phase of the PLL to the phase of the common reference signal, although in other exemplary embodiments, the phase modulation adjustment can be provided to any phase modulation port of the synthesizer. The time-varying phase compensation value from the look-up table discussed above can be combined with this phase modulation adjustment used to synchronize the synthesizers, e.g., by summing the two adjustments to form a combined phase modulation input to the delta sigma modulator.

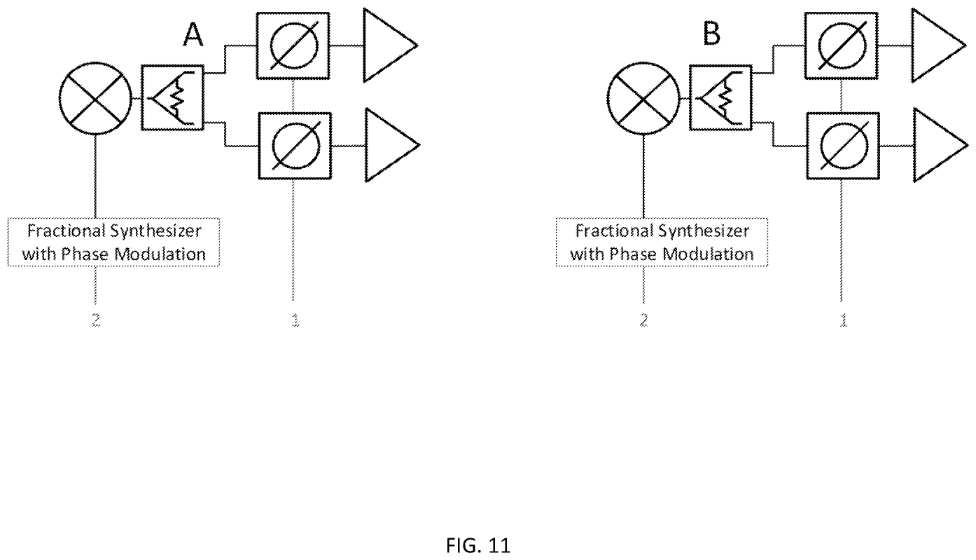

As depicted schematically in FIG. 11, in an RF communication device/system having multiple transmitters and/or receivers, calibration could involve measuring characteristics of all of the transmitters (or receivers) relative to one of them and then making corrections at point 1, e.g., so that all of the transmitters (or receivers) are synchronized with regard to a particular operating parameter (e.g., phase, amplitude, etc.). The average phase then can be measured relative to an external reference, and this can be used to make corrections at point 2.

Additionally or alternatively, in cases where the RF transmitter and/or the RF receiver have multiple channels (e.g., FIG. 6, FIG. 11), the calibration/compensation controller could have separate stored primary calibration parameters for each channel and could have separate look-up tables for each channel in order to compensate for channel-to-channel variations that could include, for example, different temperature and/or other environmental factors for each channel (e.g., different temperatures at different locations of a phased array system or integrated circuit).

It should be noted that similar primary and secondary calibration parameters could be used to set and adjust other time-varying operating parameters, such as, for example, calibration of a voltage input for a voltage-controlled oscillator, calibration of a time-to-digital converter, calibration of a digital-to-time converter, etc.

It should be noted that phased-array systems often include one or more beamforming integrated circuits (BFICs) having one or more channels of RF transmitter circuitry (e.g., circuitry that adjusts phase and/or gain of a transmit signal) and/or RF receiver circuitry (e.g., circuitry that adjusts phase and/or gain of a receive signal), for example, as shown and described with reference to FIGS. 6 and 7. Such BFICs generally have registers used to program various operating parameters such as per-channel phase and/or gain settings. These registers could be programmed with primary calibration parameters and reprogrammed using secondary calibration parameters by an external calibration/compensation controller that, for example, could store primary and secondary calibration parameters for each BFIC and could monitor one or more environmental factors and reprogram the BFICs from time to time using the secondary calibration parameters. Additionally or alternatively, a BFIC could include an integral calibration/compensation controller and related primary and/or secondary calibration parameter storage to allow the BFIC to program and/or reprogram its own operating parameters, which could be prompted by an external calibration/compensation controller (e.g., from time to time, or upon detecting a significant change in an environmental factor such as an increase or decrease in temperature). The external calibration/compensation controller could provide the environmental factor value(s) for the BFIC to use for reprogramming operating parameters using the secondary calibration parameters, or one or more environmental sensors could be included on the BFIC to allow the BFIC to independently reprogram operating parameters based on one or more locally-determined environmental factors (which, for example, would allow the BFICs of a phased array system to recalibrate based on different local environmental parameter values such as temperature differentials across a phased array system). The primary and secondary calibration parameters may be determined by an external calibration system, or, alternatively, some or all of the primary and secondary calibration parameters may be determined on-chip such as by looping back the transmitter to the receiver and using the receiver to measure traits of the transmitter.

It also should be noted that primary calibration parameters need not be separate from the secondary calibration parameters. For example, the calibration/compensation controller could use one of the secondary calibration parameters to program an initial value for an operating parameter and then could reprogram the operating parameter using the secondary calibration parameters based on changes in one or more environmental factors.

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In alternative embodiments, the disclosed apparatus and methods (e.g., as in any flow charts or logic flows described above) may be implemented as a computer program product for use with a computer system. Such implementation may include a series of computer instructions fixed on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as a tangible, non-transitory semiconductor, magnetic, optical or other memory device, and may be transmitted using any communications technology, such as optical, infrared, RF/microwave, or other transmission technologies over any appropriate medium, e.g., wired (e.g., wire, coaxial cable, fiber optic cable, etc.) or wireless (e.g., through air or space).

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads. Software systems may be implemented using various architectures such as a monolithic architecture or a microservices architecture.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., phase compensation systems, RF integrated circuits that incorporate such phase compensation systems, and phased array systems that incorporate such RF integrated circuits) are necessarily non-conventional because, absent special programming or configuration, the conventional components do not inherently perform the described non-conventional functions.

The activities described and claimed herein provide technological solutions to problems that arise squarely in the realm of technology. These solutions as a whole are not well-understood, routine, or conventional and in any case provide practical applications that transform and improve computers and computer routing systems.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/of” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

1. A system comprising:
an RF communication circuit having a phase parameter that can vary over time based on at least one environmental factor;
at least one calibration storage for storing phase calibration parameters including at least a primary phase calibration parameter and a plurality of secondary phase calibration parameters including a distinct secondary phase calibration parameter value for each of a plurality of environmental factor values; and
a controller configured to program the operating parameter based on the primary calibration parameter and adjust the operating parameter using the secondary calibration parameters based on changes of the at least one environmental factor.

2. The system of claim 1, wherein the controller is further configured to adjust for time-varying performance of the RF communication circuit using secondary calibration parameters retrieved from a look-up table based the at least one environmental factor.

3. The system of claim 2, wherein the time-varying performance includes amplitude performance and/or phase performance.

4. The system of claim 1, wherein the at least one environmental factor includes temperature and/or voltage.

5. (canceled)

6. The system of claim 1, wherein the RF communication circuit includes an RF transmitter and/or an RF receiver.

7. (canceled)

8. The system of claim 1, further comprising a beamforming integrated circuit comprising the RF communication circuit, the at least one calibration storage, and/or the controller.

9. The system of claim 8, wherein the beamforming integrated circuit is configured to operate with 5G protocols and/or operate with millimeter wave signals.

10. (canceled)

11. The system of claim 8, wherein the beamforming integrated circuit further comprises a plurality of RF communication circuits that are compensated independently or compensated collectively.

12. (canceled)

13. The system of claim 8, further comprising a phased array system comprising the beamforming integrated circuit.

14. A method comprising:
storing phase calibration parameters including at least a primary phase calibration parameter and a plurality of secondary phase calibration parameters including a distinct secondary phase calibration parameter value for each of a plurality of environmental factor values;
operating an RF communication circuit having a phase parameter that can vary over time based on at least one environmental factor;
programming the operating parameter based on the primary calibration parameter; and
adjusting the operating parameter using the secondary calibration parameters based on changes of the at least one environmental factor.

15. The method of claim 14, further comprising adjusting for time-varying performance of the RF communication circuit using secondary calibration parameters retrieved from a look-up table based the at least one environmental factor.

16. The method of claim 15, wherein the time-varying performance includes amplitude performance and/or phase performance.

17. The method of claim 14, wherein the environmental factor includes temperature and/or voltage.

18. (canceled)

19. The method of claim 14, wherein the RF communication circuit includes an RF transmitter and/or an RF receiver.

20. (canceled)

21. The method of claim 14, wherein when there are two or more signal paths, the average phase difference between the signal paths is equalized.

22. An integrated circuit comprising:
at least one RF communication circuit having a phase parameter that can vary over time based on at least one environmental factor;
at least one calibration storage for storing phase calibration parameters including at least a primary phase calibration parameter and a plurality of secondary phase calibration parameters including a distinct secondary phase calibration parameter value for each of a plurality of environmental factor values; and
a calibration/compensation controller configured to program the operating parameter based on the primary calibration parameter and reprogram the operating parameter using the secondary calibration parameters based on changes of the at least one environmental factor.

23. The integrated circuit of claim 22, wherein the secondary phase calibration parameters are stored in at least one lookup table indexed by values associated with the at least one environmental factor.

24. The integrated circuit of claim 22, wherein the at least one RF communication circuit comprises:
a plurality of RF communication circuits, each having a phase shifter; and
a mixer that modulates a carrier signal to produce a modulated signal that is distributed to the plurality of RF communication circuits, wherein:
the phase shifter of each RF communication circuit is programmed with a primary calibration parameter for calibration of the RF communication circuit;
the mixer is programmed with a primary calibration parameter for calibration of the mixer based on phase outputs of the RF communication circuits; and
at least one of (a) a phase shifter or (b) the mixer is reprogrammed using the secondary calibration parameters based on changes of the at least one environmental factor.

25. The integrated circuit of claim 24, wherein the mixer is calibrated based on an average phase difference of the RF communication circuits relative to an external reference.

26. The integrated circuit of claim 22, wherein the RF communication circuit comprises multiple transmitters and/or receivers;
wherein the calibration/compensation controller is further configured to perform a calibration process comprising measuring characteristics of all of the transmitters and receivers in the RF communication circuit relative to one of the transmitters and receivers, and synchronizing all of the transmitters and receivers with regard to the operating parameter.
